(19) United States
(12) Patent Application Publication
(10) Pub. No.: US 2006/0284583 A1
(43) Pub. Date: Dec. 21, 2006

(54) Error compensation for a wireless sensor using a rotating microstrip coupler to stimulate and interrogate a saw device

(75) Inventors: Richard M. Andrews, Freeport, IL (US); Scott L. Bunyer, Freeprot, IL (US); Fred W. Hintz, Freeport, IL (US); James ZT Liu, Hudson, NH (US); Steven J. Magee, Lena, IL (US); Gary O'Brien, Riverview, MI (US)

Correspondence Address: Kris T. Fredrick;Honeywell International Inc., 101 Columbia Rd, P.O. Box 2245, Morristown, NJ, 07962, US

(73) Assignee: Honeywell International Inc.

(21) Appl. No.: 11/311,417

(22) Filed: Dec. 16, 2005

Related U.S. Application Data
(63) Continuation-in-part of application No. 11/156,171, filed on Jun. 16, 2005, now Pat. No. 7,095,198.

(51) Int. Cl. H02P 7/00

(52) U.S. Cl. 318/432

(57) ABSTRACT

Many mechanical systems contain rotating parts used to transfer power from one part of the system to another. The system's efficiency and longevity can be increased by measuring the speed and loading of the rotating parts. Passive wireless sensors are ideal for instrumenting rotating parts because they require no connecting wires and no stored energy. The sensor measurements contain read errors when the stationary interrogation circuit and the rotating sensor are not ideally aligned. The read errors are a function of the angular offset between the stationary interrogation circuit and the passive sensor. As such, the read errors are deterministic. A measurement of the angular offset between the stationary interrogation circuit and the passive sensor is used to determine a correction factor that cancels out the read error to produce a compensated sensor signal.

### CROSS-REFERENCE TO RELATED APPLICATION

This patent application is a Continuation-in-Part (CIP) of U.S. patent application Ser. No. 11/156,171, entitled “Speed Sensor for a Power Sensor Module,” which was filed on Jun. 16, 2005 and is incorporated herein by reference in its entirety.

### TECHNICAL FIELD

Embodiments relate to mechanical power sensing and mechanical power measurement. Embodiments also relate to passive wireless sensors, SAW sensors, angular position sensing, and error compensation.

### BACKGROUND OF THE INVENTION

Machinery must often apply power generated by an engine or motor to a purpose such as drilling a hole or turning a wheel. As such, the machinery must transfer mechanical power. Mechanical power is transferred by rotating elements such as shafts, plates, and gears. For example, in a car the power generated by the engine must be transferred to the wheels. Most car engines generate power that is available on a rotating shaft called the crankshaft. The crankshaft is connected to a transmission via a clutch. A clutch effects rotary power transfer by adjusting the friction between two plates. Forcing a spinning plate's face against another plate's face causes power transfer or loss at the interface.

Torque is a force applied to cause rotation. U.S. Pat. No. 4,196,337, included here by reference, discloses a torque sensor. Power, on the other hand, is torque multiplied by rotational speed. U.S. patent application Ser. No. 11/156,171, included here by reference, discloses a power sensor module. The power sensor module employs a passive wireless sensor attached to a rotating element. Most notably, the sensor is a surface acoustic wave (SAW) torque sensor.

A passive wireless sensor obtains operational energy from an electromagnetic field. It uses the operational energy to produce a sensor measurement, to produce a sensor signal containing the sensor measurement, and to couple the sensor signal into the electromagnetic field. “Coupling a signal into the electromagnetic field” is another way of saying “transmitting a signal”.

An interrogation circuit is required for obtaining the sensor measurement. The interrogation circuit generates the electromagnetic field that energizes the passive wireless sensor. It then receives the sensor signal after the passive wireless sensor transmits it. Those skilled in the art of passive sensors, wireless sensors, and SAW devices know of many techniques for energizing passive wireless sensors and obtaining their measurements.

Torque sensors, such as those used in the power sensor module, have tight accuracy tolerances. One reason for the tight tolerances is that the errors are multiplied by the rotational speed to determine power. As such, the errors in the power measurement are many multiples higher than those in the torque sensor.

The relative rotational displacement, also called the angular offset, between certain interrogation circuits and passive wireless sensors produces read errors in the sensor measurement. Specifically, the passive wireless sensor produces an accurate sensor measurement and transmits it. The interrogation circuit, however, receives a less accurate sensor measurement. The difference between the accurate sensor measurement and the received sensor measurement is the read error.

FIG. 6, labeled as “prior art”, illustrates an angular position sensor measuring the angular offset of a magnet 108 relative to a magnetic field sensor 109. The magnet 108 is attached to a rotating element 102 that spins around an axis. The angular offset is the angle between two lines. The first line connects the magnet 108 to the rotation axis 601 and the second line connects the magnetic field sensor 109 to the rotation axis 601. A home position, or zero angle position, is reached when the magnet 108 and the magnetic field sensor 109 are closest together. As the rotating element 102 spins, magnet 108 reaches the home position at a periodic rate. Every time the magnet 108 reaches the home position, the magnetic field sensor 109 produces a home signal 114. A microprocessor 110 receives the home signal 114. An angle calculation module 601 within the microprocessor 110 uses a timing element 107, here shown as part of the microprocessor 110, and the periodically received home signal 114 to find the angular offset value 111. Those practiced in the art of angular position sensing know of this and many similar techniques for sensing or measuring offset angles.

FIG. 7, labeled as “prior art”, illustrates a lookup table 701. Lookup tables are commonly used in applications where evaluating a mathematical function is impossible or prohibitive. For example, experimental results can reveal a relationship between an independent and a dependent variable. In practice, it can be easier to use the experimental results to produce a lookup table instead of developing a mathematical function approximating the experimental results. Another example is that lookup tables can yield a result much more quickly, especially is small microcontrollers, than function evaluations. In FIG. 7, the lookup table 701 has five index values. When an input index value equals index 1 702, the value stored as value 1 703 is output. When an input index value equals index 2 704, the value stored as value 2 705 is output. When an input index value equals index 3 706, the value stored as value 3 707 is output. When an input index value equals index 4 708, the value stored as value 4 709 is output. When an input index value equals index 5 710, the value stored as value 5 711 is output. Here, an input index value 712 equaling index 2 704 is shown resulting in an output value 713 equaling value 2 705.

The embodiments disclosed herein directly address the shortcomings of conventional systems and devices by compensating for read errors due to the relative rotational displacement between interrogation circuits and passive wireless sensors.

### BRIEF SUMMARY

The following summary is provided to facilitate an understanding of some of the innovative features unique to the embodiments and is not intended to be a full description. A full appreciation of the various aspects of the embodiments can be gained by taking the entire specification, claims, drawings, and abstract as a whole.

It is therefore an aspect of the embodiments that a passive wireless sensor, such as a passive surface acoustic wave (SAW) torque sensor, is mounted to a rotating element such as a shaft, gear, or disk. The passive wireless sensor obtains energy from an electromagnetic field and uses that energy to produce a sensor measurement and a sensor signal. The sensor signal contains the sensor measurement. The sensor then couples the sensor signal into the electromagnetic field. For example, the sensor measurement can cause an offset in the resonant frequency of the sensor. The sensor then transmits a signal at the offset frequency.

A passive wireless sensor can contain separate elements for sensing and communicating. For example, a SAW torque sensor can contain a SAW device and an antenna. The SAW device senses the torque while the antenna obtains the energy and couples the signal into the electromagnetic field. The antenna and the SAW device can be electrically connected within the sensor or otherwise part of the same electrical circuit. The antenna can be any type of commonly used antenna such as a microstrip coupler, patch antenna, spring antenna, wire antenna, or even a simple wire trace patterned on a circuit board.

It is also an aspect of the embodiments that a stationary circuit creates the electromagnetic field that energizes the sensor and then receives the sensor signal transmitted by the sensor.

It is another aspect of the embodiments that an angular position sensor produces an angular offset value that indicates the angle between the passive sensor and a zero angle position. The zero angle position is a known position that provides an absolute reference against which the angular offset can be determined.

It is yet another aspect of the embodiments that an error correction module uses the angular offset value and the sensor measurement to produce a compensated sensor measurement.

In some embodiments, the angular position sensor is made of a magnet attached to the rotating element, a timing device, and a stationary magnetic field sensor, such as a magneto-resistive sensor or Hall device. The stationary magnetic field sensor produces a home signal whenever the magnet comes close. That position is the zero angle position. The home signal and the timing element are used to determine a rotational velocity and the angular offset. For example, if the home signal is generated once every second, then the rotational velocity is one rotation per second. The angular offset can be determined from the elapsed time since the last home signal. Returning to the example, 0.25 seconds after the last home signal, the angular position is 90 degrees past the zero angle position.

Certain embodiments use a microprocessor. The microprocessor can produce the angular offset. Many microprocessors contain timers. As such, a microprocessor can take the home signal as input and determine the angular offset whenever requested. Microprocessors also often contain nonvolatile memory. A microprocessor can store a lookup table that contains correction factors indexed against angular offsets. Therefore, a microprocessor can take the home signal and the sensor measurement as input and produce a compensated sensor measurement by first producing the angular offset, finding the correction factor, and applying the correction factor to the sensor measurement.

### BRIEF DESCRIPTION OF THE DRAWINGS

The accompanying figures, in which like reference numerals refer to identical or functionally similar elements throughout the separate views and which are incorporated in and form a part of the specification, further illustrate the present invention and, together with the background of the invention, brief summary of the invention, and detailed description of the invention, serve to explain the principles of the present invention.

FIG. 1 illustrates a system producing a compensated sensor measurement in accordance with an embodiment;

FIG. 2 illustrates another system producing a compensated sensor measurement in accordance with an embodiment;

FIG. 3 illustrates a high level flow diagram of producing a compensated sensor measurement in accordance with an embodiment;

FIG. 4 illustrates a graph of read errors in accordance with an embodiment;

FIG. 5 illustrates a microprocessor used in producing a compensated sensor measurement in accordance with an embodiment;

FIG. 6, labeled as “prior art”, illustrates an angular position sensor measuring the angular offset of a magnet relative to a magnetic field sensor; and

FIG. 7, labeled as “prior art”, illustrates a lookup table.

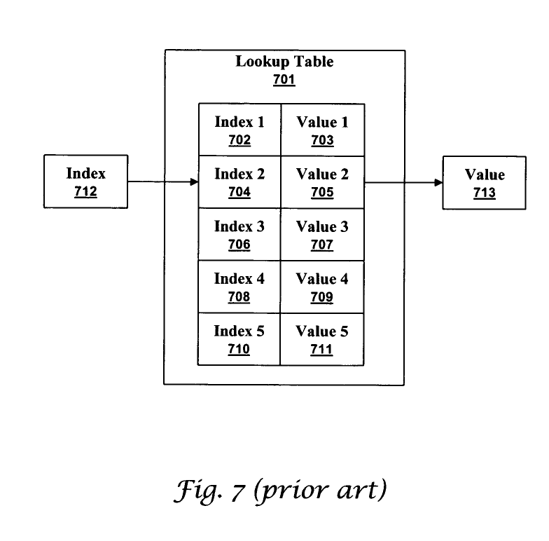

### DETAILED DESCRIPTION

The particular values and configurations discussed in these non-limiting examples can be varied and are cited merely to illustrate at least one embodiment and are not intended to limit the scope thereof. In general, the figures are not to scale.

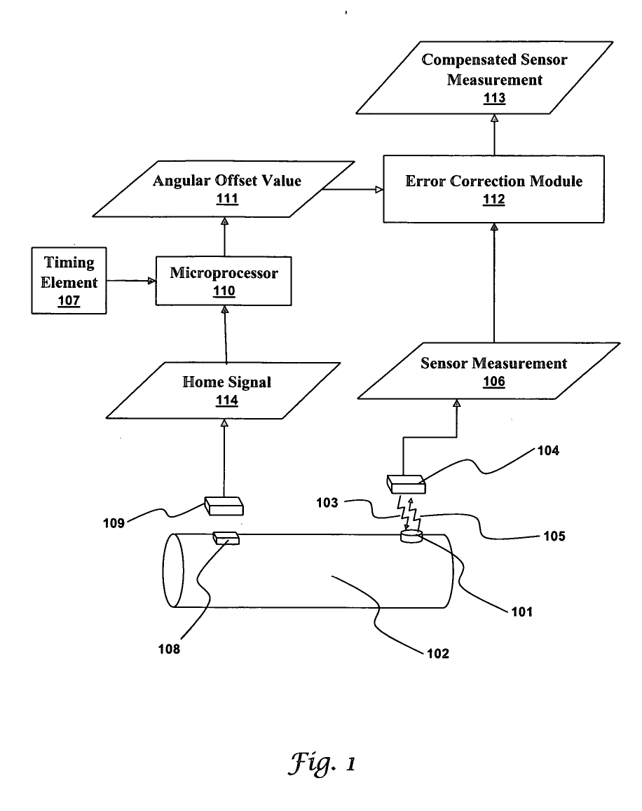

FIG. 1 illustrates a system producing a compensated sensor measurement 113 in accordance with an embodiment. A passive wireless sensor 101 is attached to a rotating element 102. A stationary circuit 104 creates an electromagnetic field 103 that energizes the passive wireless sensor 101. Here, the electromagnetic field 103 is shown as a ragged arrow to indicate the sensor it is energizing. In practice, electromagnetic fields a rarely highly directional. The passive wireless sensor 101, once energized, produces a sensor signal 105 that is transmitted back to the stationary circuit 104. The sensor signal 105 contains a sensor measurement 106. As discussed above, a read error based on the angular offset between the passive wireless sensor 101 and the stationary circuit 104 is unintentionally introduced.

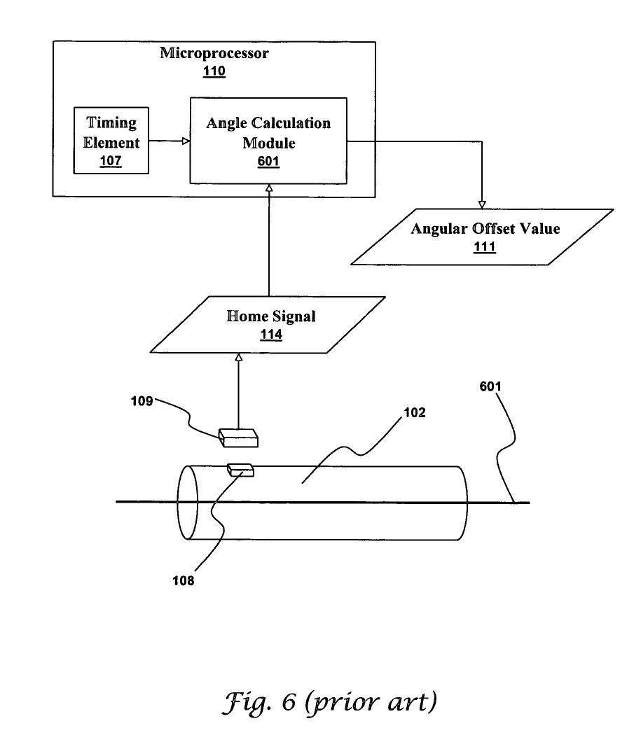

An angular position sensor, such as that illustrated in FIG. 6, is also illustrated in FIG. 1. The difference between the angular offset sensor of FIG. 1 and that of FIG. 6 is that in FIG. 1 the timing element 107 is not shown as part of the microprocessor 110. Regardless, the microprocessor 110 produces an angular offset value 111. The angular offset value 111 and the sensor measurement 106 are passed to an error correction module 112 that then produces a compensated sensor measurement 1 13.

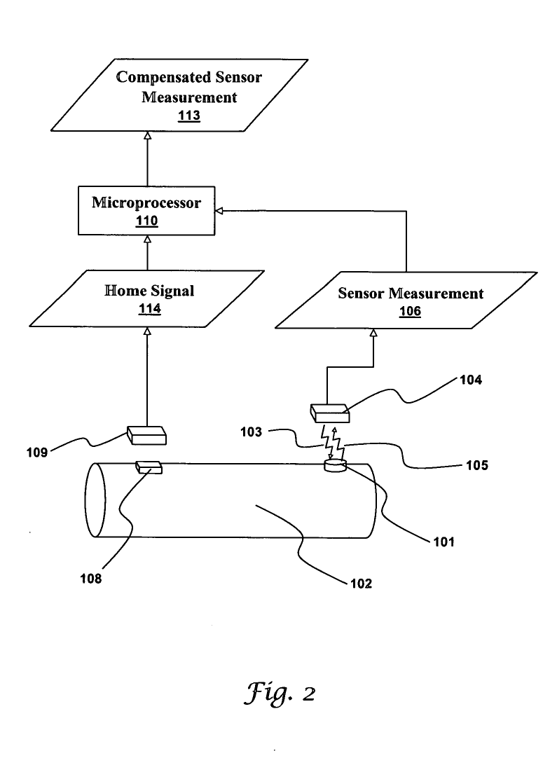

FIG. 2 illustrates another system producing a compensated sensor measurement 113 in accordance with an embodiment. The system illustrated in FIG. 2 is the same in most respects as the system illustrated in FIG. 1 with a few exceptions. The exceptions are that the microprocessor 110 now contains the timing element 107 and error correction module 112 of FIG. 1. As such, the microprocessor 110 accepts the sensor measurement 106 and the home signal 114 as input and produces the compensated sensor measurement 113.

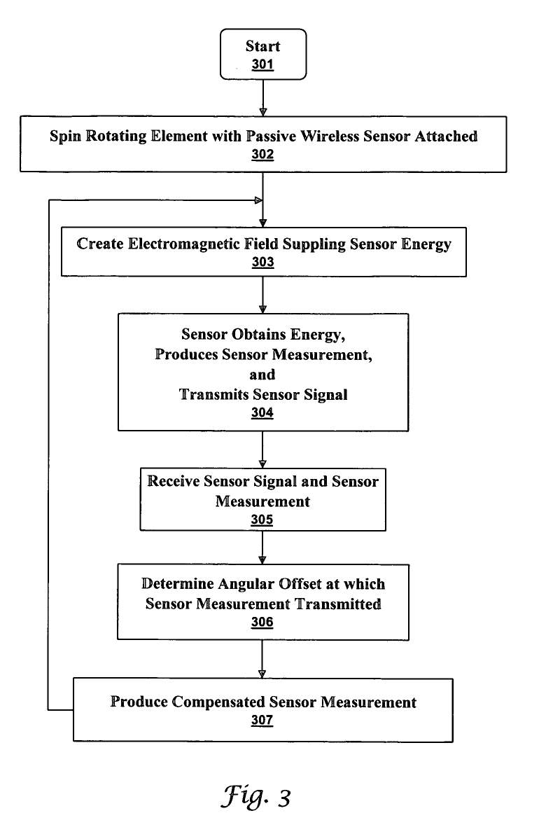

FIG. 3 illustrates a high level flow diagram of producing a compensated sensor measurement in accordance with an embodiment. After the start 301, a rotating element with an attached passive wireless sensor is spun around an axis 302. An electromagnetic field is created that supplies energy to a passive wireless sensor 303. The sensor obtains the energy and uses it to produce a sensor measurement and transmit a sensor signal containing the sensor measurement 304. The sensor signal is received and the sensor measurement is thereby also received 305. The sensor measurement now contains a read error that is a function of the angular offset between the passive wireless sensor and receiver that received the sensor signal. The angular offset is determined 306 and then used to produce a compensated sensor measurement 307. The process can then stop, but is here shown looping back to creating an electromagnetic field 303.

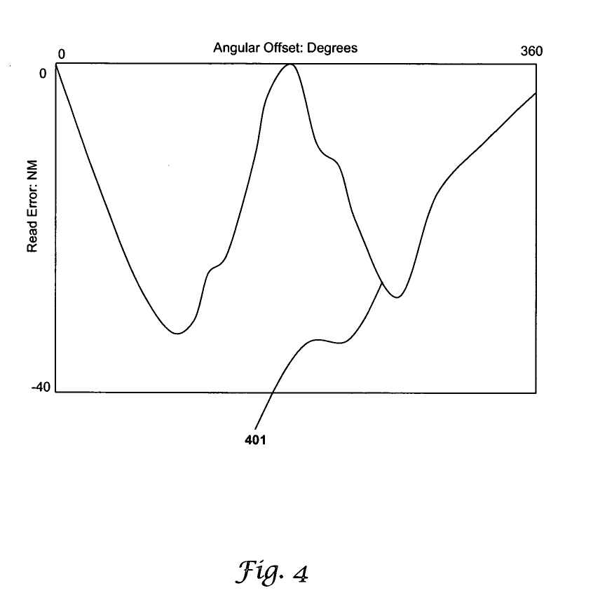

FIG. 4 illustrates a graph of read errors in accordance with an embodiment. The graph illustrated is an approximation of actual experimental data. It illustrates a curve 401 tracing the read error as a function of offset angle. The experimental data is repeatable. Furthermore, the experimental data can be used to produce a lookup table. The index into the lookup table can be the angular offset and the output can be the read error. Subtracting the read error from the sensor measurement obtained by the stationary circuit produces the compensated measurement.

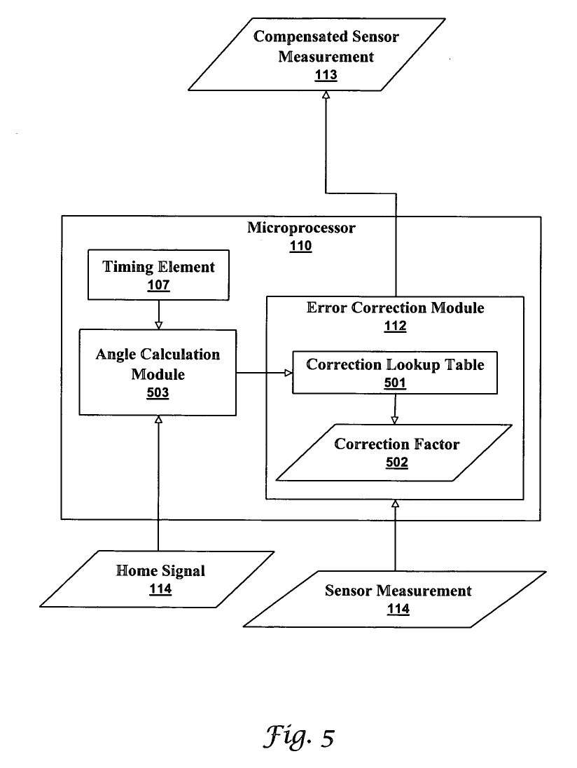

FIG. 5 illustrates a microprocessor 110 used in producing a compensated sensor measurement 113 in accordance with an embodiment. The home signal 114 is input into the microprocessor 110. An angle correction module 503 uses the home signal 114 and a timing element 107 to produce an angular offset value (not shown). The angular offset value is passed to the error correction module 112 which contains a correction lookup table 501. The angular offset value is used as an index into the correction lookup table 501 to produce a correction factor 502. The read error, discussed above and illustrated in FIG. 4, can be used as a correction factor. The error correction module 112 then uses the correction factor 502 and the sensor measurement 114 to produce the compensated sensor measurement 113.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A system comprising:
a passive wireless sensor mounted to a rotating element wherein the passive sensor obtains energy from an electromagnetic field, uses that energy to produce a sensor measurement, to produce a sensor signal comprising the sensor measurement, and to couple the sensor signal into the electromagnetic field;
a stationary circuit that creates the electromagnetic field and receives the sensor signal;
an angular position sensor that produces an angular offset value wherein the angular offset value indicates the angle between the passive sensor and a zero angle position; and
an error correction module that uses the angular offset value and the sensor measurement to produce a compensated sensor measurement.

2. The system of claim 1 wherein the passive wireless sensor is a torque sensor;

3. The system of claim 2 wherein the angular position sensor comprises a magnet attached to the rotating element, a stationary magnetic field sensor, and a timing element wherein the stationary magnetic field sensor produces a home signal whenever the magnet is at the zero angle position, and wherein the home signal and the timing element are used to determine a rotational velocity and the angular offset value.

4. The system of claim 3 further comprising a microprocessor that determines the angular offset value and wherein the microprocessor produces the compensated sensor measurement.

5. The system of claim 4 further comprising a correction lookup table wherein the microprocessor uses the angular offset value to index into the correction lookup table and thereby obtains a correction factor, and wherein the microprocessor applies the correction factor to the sensor measurement to produce the compensated sensor measurement.

6. The system of claim 1 wherein the angular position sensor comprises a magnet attached to the rotating element, a stationary magnetic field sensor, and a timing element wherein the stationary magnetic field sensor produces a home signal whenever the magnet is at the zero angle position, and wherein the home signal and the timing element are used to determine a rotational velocity and the angular offset value.

7. The system of claim 6 further comprising a microprocessor that determines the angular offset value and wherein the microprocessor produces the compensated sensor measurement.

8. The system of claim 7 further comprising a correction lookup table wherein the microprocessor uses the angular offset value to index into the correction lookup table and thereby obtains a correction factor, and wherein the microprocessor applies the correction factor to the sensor measurement to produce the compensated sensor measurement.

9. A system, comprising:
a passive wireless SAW sensor mounted to a rotating element wherein the passive sensor obtains energy from an electromagnetic field, uses that energy to produce a sensor measurement, to produce a sensor signal comprising the sensor measurement, and to couple the sensor signal into the electromagnetic field;
a stationary circuit that creates the electromagnetic field and receives the sensor signal;
an angular position sensor that produces an angular offset value wherein the angular offset value indicates the angle between the passive sensor and a zero angle position; and
an error correction module that uses the angular offset value and the sensor measurement to produce a compensated sensor measurement.

10. The system of claim 9 wherein the passive wireless SAW sensor is a torque sensor;

11. The system of claim 10 wherein the angular position sensor comprises a magnet attached to the rotating element, a stationary magnetic field sensor, and a timing element wherein the stationary magnetic field sensor produces a home signal whenever the magnet is at the zero angle position, and wherein the home signal and the timing element are used to determine a rotational velocity and the angular offset value.

12. The system of claim 11 further comprising a microprocessor that determines the angular offset value and wherein the microprocessor produces the compensated sensor measurement.

13. The system of claim 12 further comprising a correction lookup table wherein the microprocessor uses the angular offset value to index into the correction lookup table and thereby obtains a correction factor, and wherein the microprocessor applies the correction factor to the sensor measurement to produce the compensated sensor measurement.

14. The system of claim 9 wherein the angular position sensor comprises a magnet attached to the rotating element, a stationary magnetic field sensor, and a timing element wherein the stationary magnetic field sensor produces a home signal whenever the magnet is at the zero angle position, and wherein the home signal and the timing element are used to determine a rotational velocity and the angular offset value.

15. The system of claim 14 further comprising a microprocessor that determines the angular offset value and wherein the microprocessor produces the compensated sensor measurement.

16. The system of claim 15 further comprising a correction lookup table wherein the microprocessor uses the angular offset value to index into the correction lookup table and thereby obtains a correction factor, and wherein the microprocessor applies the correction factor to the sensor measurement to produce the compensated sensor measurement.

17. A method comprising:
spinning a rotating element around an axis wherein a passive wireless sensor attached to the rotating element also rotates around the axis;
creating an electromagnetic field from which the passive sensor obtains energy;
receiving a sensor signal from the passive sensor wherein the passive sensor used the energy to produce a sensor measurement, create a sensor signal comprising the sensor measurement, and to couple the sensor signal into the electromagnetic field;
obtaining the sensor measurement from the sensor signal;
determining an angular offset value between the passive sensor and a zero angle position at the moment the sensor transmitted the sensor signal; and
using the angular offset value and the sensor measurement to produce a compensated sensor measurement.

18. The method of claim 17 further comprising:
generating a home signal indicating that a magnet on the rotating shaft has reached the zero angle position;
timing the generation of the home to determine a rotational velocity; and
determining the angular offset value from the home signal and the rotational velocity.

19. The method of claim 17 further comprising:
using a microprocessor to determine the angular offset value; and
using the microprocessor to produces the compensated sensor measurement.

20. The method of claim 19 further comprising:
using the angular offset value as an index into a correction lookup table and thereby obtaining a correction factor; and
applying the correction factor to the sensor measurement to produce the compensated sensor measurement.
